(19) United States
(12) Patent Application Publication
(10) Pub. No.: US 2016/0140766 A1
(43) Pub. Date: May 19, 2016

(54) Surface projection system and method for augmented reality

(71) Applicant: SULON TECHNOLOGIES INC., Markham (CA)

(72) Inventors: Dhanushan Balachandreswaran, Richmond Hill (CA); Tharoonan Balachandreswaran, Richmond Hill (CA)

(21) Appl. No.: 14/998,373

(22) Filed: Dec. 24, 2015

Related U.S. Application Data
(63) Continuation-in-part of application No. 14/102,819, filed on Dec. 11, 2013, now abandoned.
(60) Provisional application No. 61/736,032, filed on Dec. 12, 2012.

(51) Int. Cl. G06T 19/00; G06F 3/00; G02B 27/01; G06F 3/01

(52) U.S. Cl. CPC G06T 19/006; G06F 3/017; G06F 3/005; G06F 3/011; G02B 27/0172; G02B 2027/0138; G02B 2027/014

(57) ABSTRACT

A surface projection system for augmented reality is provided. The surface projection system includes a surface projection device that is positionable adjacent a surface and having a light element and a sensor. The light element is configured to project a reference pattern on the surface. The sensor is positioned adjacent the surface and configured to gaze along the surface.

### TECHNICAL FIELD

The present invention relates generally to the field of augmented reality technologies, and specifically to a surface projection system and method for augmented reality.

### BACKGROUND OF THE INVENTION

In certain applications, augmented reality (“AR”) is the process of overlaying or projecting computer-generated images over a user's view of a real physical environment. One way of generating AR is to capture an image/video stream of the physical environment by one or more cameras mounted on a head mounted display (“HMD”) and processing the stream to identify physical indicia which can be used by the HMD to determine its orientation and location in the physical environment. The computer-generated images are then overlaid or projected atop of the user's view of the physical environment to create an augmented reality environment. This is either achieved by modifying the image/video stream to include the computer-generated images, by presenting the computer-generated images on a transparent lens positioned in front of the user's view, or by projecting light images atop of the physical environment.

Tracking such indicia can be difficult in some environments, however. For example, where a user is standing above a table, the edges of the table can be used as indicia. As the user moves closer to the table, the edges may no longer be captured by the camera(s) of the HMD, making referencing to the real environment more difficult, especially as the user's head and the HMD moves relative to the physical environment.

Interaction with such AR environments is often achieved by gesturing with a user's hands or an object held by the user in the view of the camera(s) on the HMD, processing the captured images/video stream to identify and recognize the gestures, and then modifying the computer-generated images in response to the recognized gestures. Detection of contact gestures with such AR environments can be difficult, however, as it can be difficult to detect when a user's hand or an object held by a user comes into contact with a surface such as a table on which computer-generated images are being overlaid.

### SUMMARY

In one aspect, a surface projection system for augmented reality is provided, comprising: a surface projection device positionable adjacent a surface, comprising: a light element configured to project a reference pattern on the surface, and a sensor adjacent the surface and configured to gaze along the surface.

The sensor can be configured to detect one of light interference and sound interference along the surface.

The reference pattern projected by the light element can be invisible to a human eye, such as infrared light.

The reference pattern can include a grid pattern.

The reference pattern can include a boundary for the surface.

The sensor can comprise a camera.

The surface projection system can further comprise a processor configured to recognize gesture input captured by the camera. The processor can be configured to cause the light element to transform the projected reference pattern in response to the recognized gesture input The reference pattern projected can be one of translated along the surface, scaled, and rotated.

The light source can project an object at a location in the reference pattern.

The surface projection system can further comprise a head mounted display having a camera configured to capture the reference pattern on the surface. The head mounted display can further comprise a processor configured to generate and overlay computer-generated imagery (“CGI”) atop of the reference projection via the head mounted display. The location of the object can be transformed as the reference pattern is transformed.

The surface project device can comprise a communications module configured to communicate gesture input registered by the sensor to a head mounted display.

The surface projection device can further comprise a communications module configured to communicate with a head mounted display, and a processor configured to use the reference pattern captured by the camera to measure at least one dimension of the reference pattern projected on the surface and communicate the at least one dimension to the head mounted display via the communications module.

In another aspect, there is provided a surface projection system for augmented reality, comprising: a surface projection device, comprising: a light element configured to project a reference pattern on a plane, and a sensor adjacent the plane and configured to gaze along the plane.

In a further aspect, there is provided a surface projection system for augmented reality, comprising: a surface projection device positionable adjacent a surface, comprising: a light element configured to project a reference pattern on a surface, and a sensor adjacent the surface and configured to gaze along the surface; and a head mounted display, comprising: a camera configured to capture the reference pattern on the surface, and a processor configured to generate and overlay CGI atop of the reference pattern.

These and other aspects are contemplated and described herein. It will be appreciated that the foregoing summary sets out representative aspects of a surface projection system and method for augmented reality to assist skilled readers in understanding the following detailed description.

### BRIEF DESCRIPTION OF THE DRAWINGS

A greater understanding of the embodiments will be had with reference to the Figures, in which:

FIG. 1 is a front view of a surface projection device (“SPD”) forming part of a surface projection system for AR in accordance with an embodiment;

FIG. 2 is a schematic diagram of various physical elements of the SPD of FIG. 1;

FIG. 3 shows the SPD of FIG. 1 projecting a reference pattern on a surface, the reference pattern being registered by an AR HMD;

FIGS. 4a and 4b show a user wearing the AR HMD of FIG. 3 that presents to the user computer-generated objects aligned with the reference pattern generated by the SPD overlaid atop of the physical environment;

FIG. 5 shows the AR HMD capturing a reference pattern projected by the SPD and generating objects that are presented to the user wearing the AR HMD aligned with the reference pattern;

FIG. 6 shows the imaging system of the AR HMD of FIG. 3;

FIG. 7 shows the method of transforming the reference pattern in response to registered gesture input;

FIG. 8 shows the method of generating an AR image using the AR HMD of FIG. 3 and the SPD of FIG. 1; and

FIG. 9 shows an example of a projected pattern that can be used to play a chess game.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The present disclosure is directed to systems and methods for augmented reality (AR). However, the term “AR” as used herein may encompass several meanings. In the present disclosure, AR includes: the interaction by a user with real physical objects and structures along with virtual objects and structures overlaid thereon; and the interaction by a user with a fully virtual set of objects and structures that are generated to include renderings of physical objects and structures and that may comply with scaled versions of physical environments to which virtual objects and structures are applied, which may alternatively be referred to as an “enhanced virtual reality”. Further, the virtual objects and structures could be dispensed with altogether, and the AR system may display to the user a version of the physical environment which solely comprises an image stream of the physical environment. Finally, a skilled reader will also appreciate that by discarding aspects of the physical environment, the systems and methods presented herein are also applicable to virtual reality (VR) applications, which may be understood as “pure” VR. For the reader's convenience, the following may refer to “AR” but is understood to include all of the foregoing and other variations recognized by the skilled reader.

The following provides a surface projection system and method for AR. The surface projection system includes an SPD positionable adjacent a surface. The SPD has a light element foregoing and other variations recognized by the skilled reader.

The following provides a surface projection system and method for AR. The surface projection system includes an SPD positionable adjacent a surface. The SPD has a light element foregoing and other variations recognized by the skilled reader.

The following provides a surface projection system and method for AR. The surface projection system includes an SPD positionable adjacent a surface. The SPD has a light element foregoing and other variations recognized by the skilled reader.

The following provides a surface projection system and method for AR. The surface projection system includes an SPD positionable adjacent a surface. The SPD has a light element foregoing and other variations recognized by the skilled reader.

The following provides a surface projection system and method for AR. The surface projection system includes an SPD positionable adjacent a surface. The SPD has a light element foregoing and other variations recognized by the skilled reader.

The following provides a surface projection system and method for AR. The surface projection system includes an SPD positionable adjacent a surface. The SPD has a light element configured to project a reference pattern on the surface, a sensor adjacent the surface, and

[symbol]

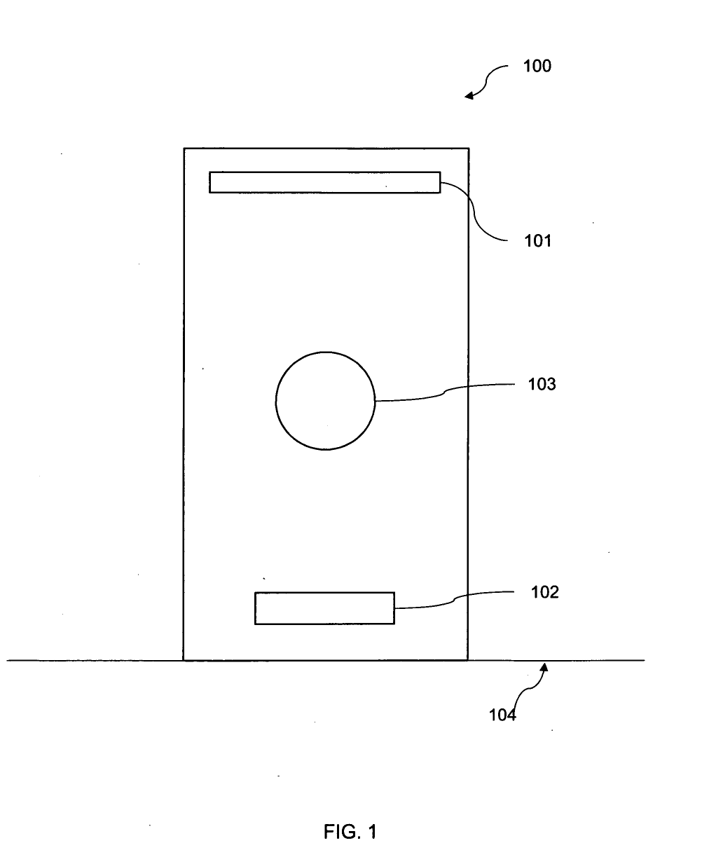

SPD 100 comprises a pattern projector 101 for projecting a pattern of light onto a surface. Pattern projector 101 is a light element that includes one or more light sources, lenses, collimators, etc. The light pattern projected by pattern projector 101 serves as a reference pattern and may include objects forming part of an AR environment. As shown in FIG. 1, the pattern projector 101 may be disposed at a substantial distance from the surface 104 to which it is projected, such that the projection is permitted to reach extents of the surface. The reference pattern provides indicia that can be recognized by a camera, such as that of an AR HMD. The reference pattern can be light that is visible to the human eye, such as laser or a holographic image, invisible, such as infrared light, or a combination of both. Further, the reference pattern can be predefined, such as an object or a repeated design, or random. Still further, the reference pattern can be purely spatial or at least partially temporal that changes predictably. Still yet further, the reference pattern can be boundaries, patterns within boundaries, or a combination of both.

SPD 100 has at least one sensor configured to gaze along the surface for detecting input at and/or adjacent to the surface. That is, the sensors have a “field of view” along a plane parallel to the surface. In particular, SPD 100 has an interference detector 102 and a complementary metal-oxide-semiconductor (“CMOS”) camera 103.

Interference detector 102 is positioned proximate the bottom of SPD 100 (that is, adjacent a surface 104 upon which SPD is positioned) and beams a plane of either light or ultrasonic waves along the surface. Where interference detector 102 uses light, preferably the light wavelength selected is not normally visible to the human eye, such as infrared light. The light used can alternatively be visible in other scenarios, such as laser light. Interference detector 102 also has a corresponding optical or ultrasonic sensor, respectively, to determine whether touch input is registered along the surface. Touch input is contact between an object, such as the finger of the user, and the surface. When an object touches the surface, it breaks the plane of light or ultrasonic waves and reflects light or sound back to the sensor of interference detector 102, which interprets the reflected light or sound as touch input. It will be understood that, in some cases, the sensor can determine distance to the object (such as a finger) interfering with the light or sound beamed by interference detector 102.

CMOS camera 103 also faces the general region above and adjacent the surface being projected on to capture gesture-based input. CMOS camera 103 can alternatively be any suitable camera that can register gestures above and adjacent the surface and enable different types of gestures to be distinguished.

SPD 100 is designed to be positioned adjacent the surface 104 onto which it projects the reference pattern and along which it registers gesture inputs, such that interference detector 102 can detect touch input along the surface by interference. For example, SPD 100 can be placed on a table and a portion of the table can provide a surface upon which the reference pattern is projected. SPD 100 may also be placed on another object adjacent the surface or secured in a position adjacent the surface. In this position, SPD 100 registers input that is different than registered by other devices distal from the surface, such as a camera on a head mounted display.

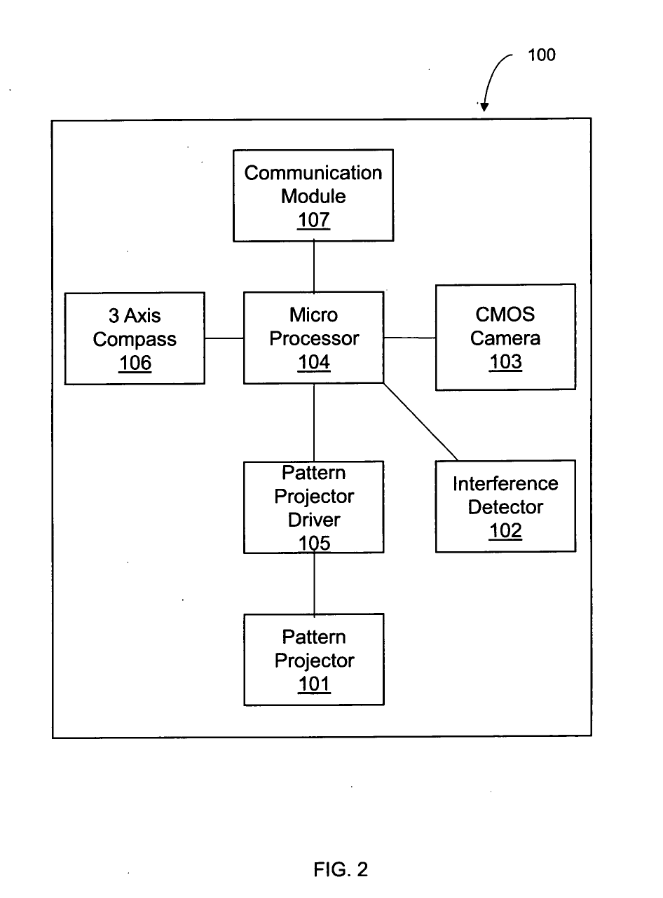

FIG. 2 is a schematic diagram of various physical components of SPD 100. In addition to pattern projector 101, interference detector 102, and CMOS camera 103, SPD 100 includes a microprocessor 104, a pattern projector driver 105, a 3-axis compass 106, and a communications module 107. Microprocessor 104 controls pattern projector driver 105 to cause pattern projector 101 to project the reference pattern onto the surface. Images from CMOS camera 103 are processed by microprocessor 104 to identify and classify gesture input. Microprocessor 104 also uses images from interference detector 102 to determine if the gesture input includes touch input.

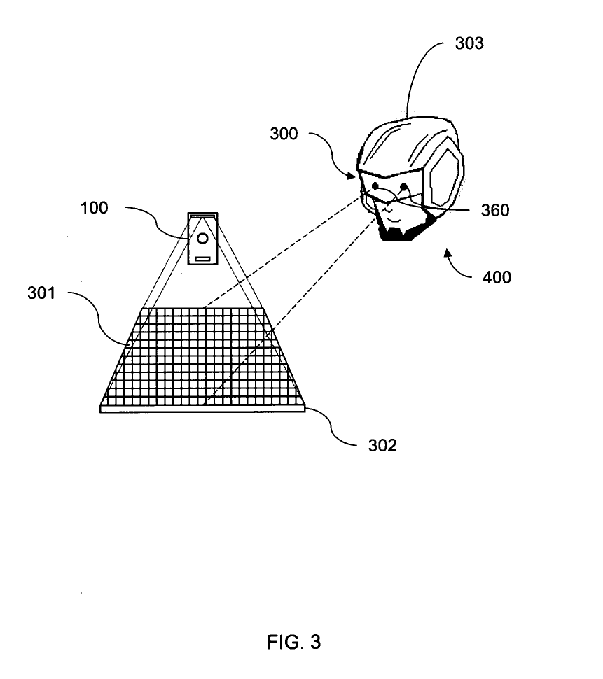

Communications module 107 can be any type of module that is configured to communicate directly or indirectly with an HMD. Communications module 107 can use wired communications, such as Ethernet, USB, FireWire, etc. Alternatively, communications module 107 can use wireless communications, such as WiFi, Bluetooth, RF, etc. In the embodiment shown, communications module 107 is configured to communicate via WiFi. An AR HMD 300 used in conjunction with SPD 100 in the surface projection system for AR is shown in FIG. 3. AR HMD 300 is configured to detect a reference pattern 301 projected by SPD 100 onto a surface 302, such as of a table or mat. For detection and acquisition of the physical environment, AR HMD 300 contains one or more cameras 360 that can scan and view surface 302 in 3D, and are able to detect reference pattern 301. Additionally, AR HMD 300 comprises a location, motion and orientation (LMO) system 303 to determine its direction, orientation and speed relative to surface 302 and/or SPD 100. This information is relayed to SPD 100 via a wireless communications module of AR HMD 300. If the user turns his head enough, AR HMD 300 will no longer see the projected reference pattern. For that reason, AR HMD 300 can be equipped with additional pose tracking means, including an inertial motion unit or a compass able to track the pose of AR HMD 300 relative to that of SPD 100. AR HMD 300 is configured to generate graphical objects and textures via a processor unit that processes data collected from cameras 360 and other sensors. AR HMD 300 also contains a screen or other form of display in order to provide AR images/video to a user 400 wearing AR HMD 300. A battery management and supply unit provides power to AR HMD 300.

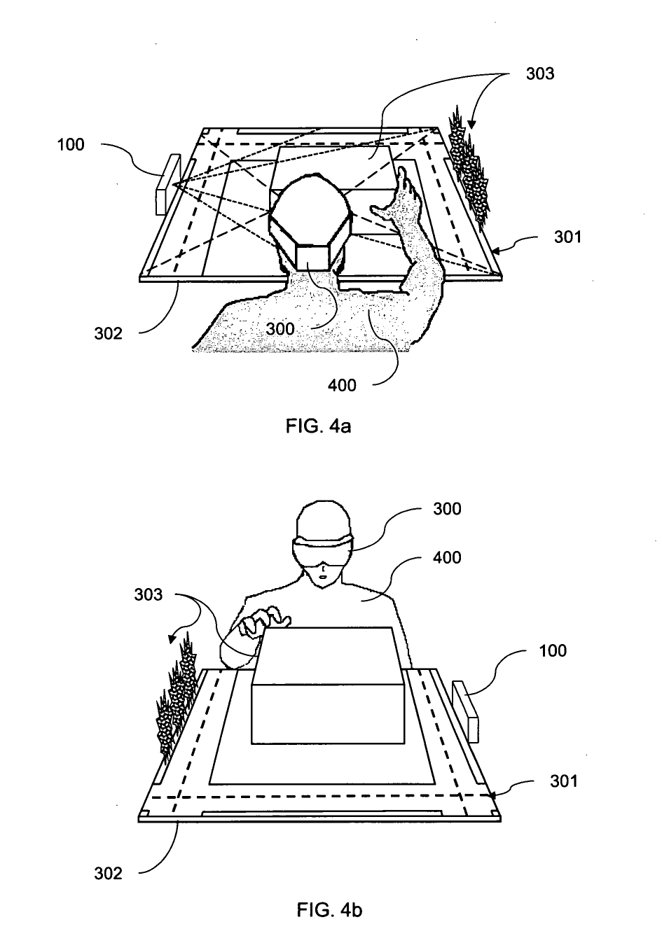

SPD 100 generates reference patterns 301 that are projected onto surface 302, as shown in FIG. 3 and FIG. 4. SPD 100 is able to detect its orientation via compass 104 and can be configured to accordingly adjust the orientation and projection of reference pattern 301 to correspond with a detected surface. Projected reference patterns 301 thereafter can be any shape or size, abstract design or property depending on projected boundaries.

SPD 100 projects light onto a surface, and captures the reflection of that light by CMOS camera 103. SPD 100 is pre-calibrated to know the dimensions of the reference pattern when SPD 100 is placed on a flat surface onto which it projects. If the surface isn't flat, then CMOS camera 103 of SPD 100 will detect the distortion of the pattern when reflected from the surface. SPD 100 reverse projects the captured image to determine an appropriate correction for the dimensions of the projected pattern. SPD 100 communicates the dimensions to AR HMD 300. However, SPD 100 may also be tilted, etc. To account for that, SPD 100 may be equipped with an inertial measurement unit. Again, SPD 100 can communicate that information to AR HMD 300. Since SPD 100 detects the location of any interference from its own POV, it can account for its relative position when communicating the location of the interference to AR HMD 300.

SPD 100 enables users to interact with reference pattern 301 as well as the augmented world generated by AR HMD 300 using their fingers and physical gestures. Computer-generated imagery (“CGI”) can be used with other techniques to create images and objects that coexist with elements created by AR HMD 300. SPD 100 can project visible characteristics or surface characteristics such as rain, snow or sand by augmenting the CGI through AR HMD 300. Once these effects are displayed by AR HMD 300 to user 400, user 400 can then control these surface or visible characteristics.

FIGS. 4a and 4b illustrate user 400 interacting with an AR environment created using SPD 100. SPD 100 creates and projects reference pattern 301 on surface 302 that can be detected by AR HMD 300 or other imaging systems. Reference pattern 301 can be a grid, and can define boundaries or any other game properties that are to be used as inputs for an AR system. Through AR HMD 300, reference pattern 301 can be detected and used as input to develop the associated graphics and objects 303 that virtually overlay surface 302 and reference pattern 301. SPD 100 measures the size of the projected reference pattern via CMOS camera 103 and relays this information to AR HMD 300. AR HMD 300 uses the dimensions of reference pattern 301 provided by SPD 100 to generate and scale graphics and objects 303 to be overlaid on the reference pattern 301. Reference pattern 301 can also be transformed via movement, scaling, and reorientation and this behaviour can be detected with AR HMD 300. In some configurations, reference pattern 301 can be made to be visible or invisible to user 400, such as by using infrared light and other visible light wavelengths in tandem, depending on their preference or game settings.

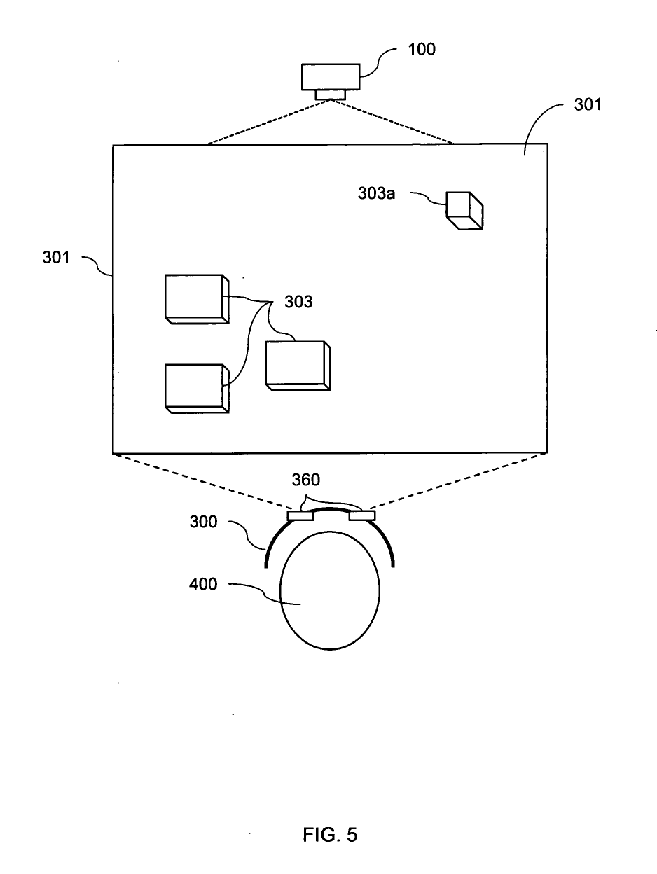

FIG. 5 shows an overhead view of SPD 100 and reference pattern 301 projected onto surface 302, which can be detected and delineated using cameras 360 of AR HMD 300. The processing unit located in AR HMD 300, which is used for generating the augmented reality, generates one or more virtual 3D objects 303 (including, in FIG. 5, 303a) to be overlaid on reference pattern 301. Reference pattern 301 is then masked by virtual 3D objects 303 in two dimensions (2D) or 3 dimensions (3D) in the image produced by AR HMD 300 and presented to user 400. As the user moves, the reference pattern 301 moves relative to the AR HMD 300, and virtual 3D objects 303 are also moved in the AR HMD 300 display since it is locked to its specific location in reference pattern 301. It will be understood that virtual 3D objects can be unlocked from a specific location on reference pattern 301 in some circumstances, such as for movable playing pieces that may be set down.

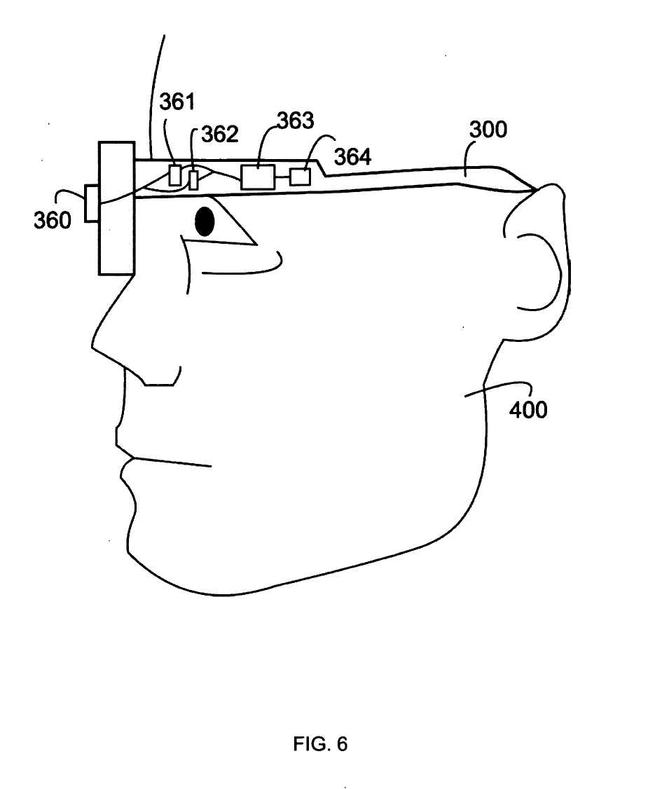

Reference pattern 301 can be reflected off the physical surface 302 and detected by AR HMD 300. In various embodiments, the reference pattern 301 may be or may not be visible to the user but is detectable by cameras 360 and image processor 363 of AR HMD 300, as shown in FIG. 6. SPD 100 can generate and project visible or infrared surface properties that can be seen and interfaced through AR HMD 300.

As shown in FIG. 6, the imaging system of AR HMD 300 includes imaging sensors for visible light 361 and/or infrared light 362, an image processor 363, and other processors 364. Processors 363, 364 and sensors 361, 362 analyze the visual inputs from camera 360 or any other video source. Camera 360 is able to send images to the central processing unit also located in AR HMD 300 for pattern recognition. Virtual 3D objects 303 can then be created using AR HMD's 300 graphics processing engine to be used in conjunction with reference pattern 301 created by SPD 100. Virtual 3D objects 303 and reference pattern 301 can be locked to surface 302 so as when camera 360 of AR HMD 300 pans around physical surface 302, the augmented images will be fixed to that physical pattern. Through imaging system of AR HMD 300, user 400 can virtually manipulate projected cities, countries, buildings and other objects augmented onto the surface.

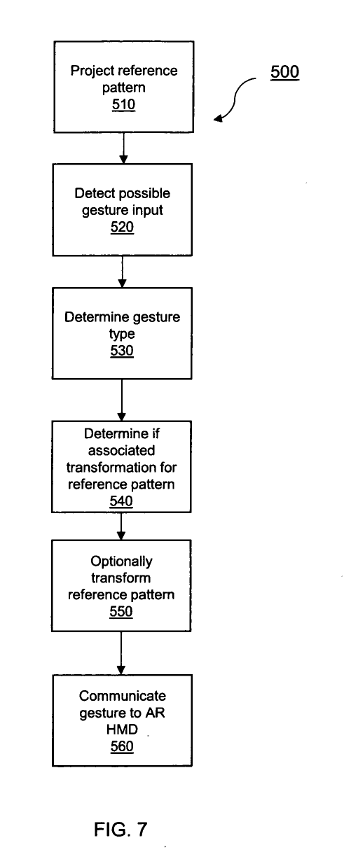

FIG. 7 shows the general method 500 of receiving and acting on gesture input executed by SPD 100. The example below relates to gameplay but is similarly applicable to other applications outside of gameplay. SPD 100 is used to provide gesture recognition or interference recognition by implementing a method in microprocessor 104. This method allows user 400 to interact physically with surface 302 to transform the AR environment presented by AR HMD 300. When reference pattern 301 is projecting reference pattern 301 onto surface 302, SPD 100 can be directed to transform reference pattern 301 and/or interact with objects 303 overlaid atop reference pattern 301, and thus the AR scene generated using AR HMD 300. For example, a playing area for a game may extend beyond surface 302. Through gestures, SPD 100 can be directed to transform reference pattern 301 to cause AR HMD 300 to present a different portion of the playing area. Further, gestures can direct movement of playing pieces in the playing area. The ability to manipulate projected virtual objects 303 may entail user 400 having to make strategic movements of components in a virtual city or virtual building blocks tied to the other teammate, or the opponents may be linked to control points in more complex parametric gaming maps.

The method 500 commences with the projection of reference pattern 301 by SPD 100 on surface 302 (510). Next, SPD 100 detects possible gesture input (520). Gesture input can be detected by interference detector 102 and/or CMOS camera 103. For example, user 400 may swipe two fingers across surface 302 to pan, rotate or otherwise transform the playing area, to present a different portion of the playing area of the game. The gesture is registered via CMOS camera 103 and touch input corresponding to the gesture is registered by interference detector 102. Microprocessor 104 then processes images from interference detector 102 and from CMOS camera 103 and determines the type of gesture input has been received (530). Gesture types can include, for example, single or multiple finger swipes, pinches, expansions, taps, twists, grabs, etc. Based on the type of gesture received, SPD 100 determines if there is an associated transformation for reference pattern 301 (540). Recognized transformations can include, for example, translating reference pattern 301, scaling reference pattern 301 by expanding or collapsing, rotating reference pattern 301, panning/moving reference pattern 301 to center on a tapped location within the boundaries of surface 302, etc. SPD 100 then optionally transforms reference pattern 301 (550). For some transformations, there can be benefit to transforming reference pattern 301 according to certain patterns. For example, where user 400 swipes along surface 302, reference pattern 301 can be translated in the direction of the swipe and decelerated to a location after a time. If the gesture input detected doesn't match a transformation type recognized by SPD 100 for transforming reference pattern 301, then reference pattern 301 is untransformed in response to the gesture. Then the gesture input is communicated to AR HMD 300 (560). SPD 100 communicates the gesture input from both interference detector 102 and gesture detector camera 103 via communications module 107 to AR HMD 300 for processing to determine if AR graphics overlaid atop of reference pattern 301 are to be transformed. Transformations include, for example, the moving of a playing piece in response to a tap or grab.

As will be understood, method 500 is repeatedly performed during operation of SPD 100 and AR HMD 300. SPD 100 is better suited to capture the presence of touch input due to its proximity to surface 302, and this detected touch input can be combined with other spatial information from camera 360 of AR HMD 300 to identify gestures.

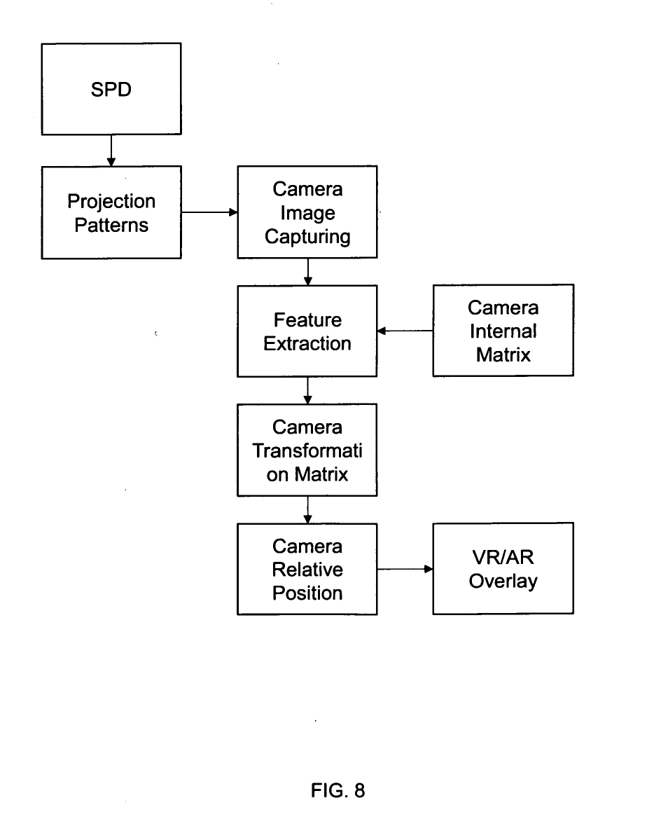

FIG. 8 shows a flowchart of how SPD 100 and AR HMD 300 work together to create virtual objects that are located on specific coordinates on reference pattern. SPD 100 projects reference pattern 301 on surface 302. The image capturing system of AR HMD 300 captures reference pattern 301 and extracts the feature points in reference pattern 301. According to the image capturing device or internal parameters, 3D transformation matrix of camera 360 is calculated based on feature points matching. The relative position and orientation of camera 360 to surface 302 is estimated and is used for VR/AR content overlaying.

In alternative embodiments, the pattern projector includes a holographic optical element or diffractive optics that generate a reference pattern along a plane defining a virtual surface. The pattern projector creates microscopic patterns that transform the origin point of the light emitting source into precise 2D or 3D images along the plane. The SPD has the adaptability to accommodate several surface interactive software developments due to its ability to dynamically map surfaces. The 3-axis compass can also determine the orientation of the SPD when it is projecting the reference pattern on the surface.

Projected pattern 301 also allows for touch and movement of user 400 to be detected and to be used as methods for input. Using the gestures, including touch input, the system can determine the position of the area of user 400 engaged interaction on reference pattern 301.

AR HMD 300 is able to create a dynamic and adaptable augmented reality where virtual objects naturally respond to the physics and movement of gestures and touches. Three-dimensional (3D) or two-dimensional (2D) objects 303 are placed on a projected surface that can then be mapped to reference pattern 301. Projected pattern 301 is able to move and, because virtual object 303 is locked to reference pattern 301, virtual object 303 can move along with reference pattern 301. AR HMD 300 is able to track virtual objects 303 associated with reference pattern 301. As user 400 interacts with virtual object 303 with hand gestures, virtual object 303 and reference pattern 301 respond to the gesture. Any physical objects on the projected surface can be tracked with AR HMD 300 or SPD 100. SPD 100 is able to apply the pattern via pattern projector 101 onto surface 302 in which it is represented by augmented images.

The coordinate system of AR HMD 300 is referenced to SPD 100 so that the interactive software or interaction with AR HMD 300 can be set. The coordinate system is also used to ensure that the appropriate orientation and display of virtual objects 303 and reference pattern 301 are displayed to multiple AR HMDs 300 when used in a multi-user setting. Wireless communication between AR HMD 300 and SPD 100 allows tracking of the position of each AR HMD 300, which can then be made known to other AR HMDs 300 and SPD 100.

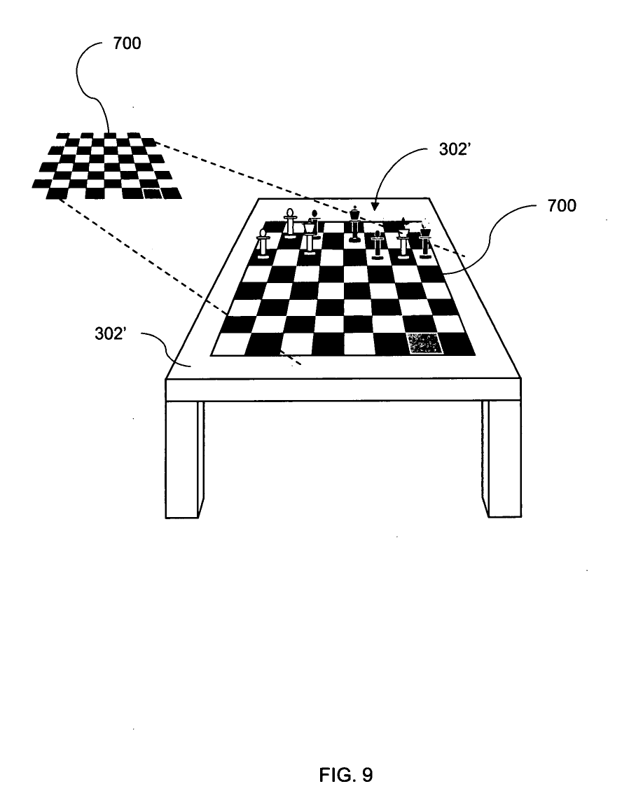

FIG. 9 shows one embodiment for playing an augmented reality chess game. An infrared reference pattern from SPD 100 creates a chess board 700 of the chess game on a surface 302′ of a table. AR HMD 300 then sees this reference pattern and augments or overlays computer-generated graphics, characters or objects by using the chessboard grid created by the reference pattern as the boundaries of the chess board squares. AR HMD(s) 300 uses the projected reference pattern on surface 302′ as the input parameters to define the game size, behaviour, or other properties. SPD 100 and camera 360 of AR HMD 300 can determine user interaction from hand movements or the like on or above surface 302′.

Other embodiments allow for features such as animated 3D and 2D images and objects to be displayed with this system as well having the ability to display and animate text.

In another embodiment, the SPD or a server to which it is connected can be polled by the AR HMD for interference detection corresponding to touch input along a surface.

Additionally, in alternative embodiments, the SPD can have a built in full inertial measurement unit instead of or in addition to a 3-axis compass that can determine its orientation. The inertial measurement unit can allow the SPD to detect and create correlating coordinate systems that aid in the human or object interaction with virtual objects on the projected surface.

While, in the above described embodiment, the SPD processes input to detect gestures, it can be desirable to have the SPD communicate all input from the interference detector and the gesture detector camera to an AR HMD for processing and gesture recognition. In such cases, the AR HMD can recognize gestures associated with the transformation of the reference pattern, and can direct the SPD to transform the reference pattern accordingly.

The interference detector may not have a light source in some embodiments and can use light projected by the pattern projector and reflected off of the user and/or objects at or above the surface to detect interference with the surface.

Although the foregoing has been described with reference to certain specific embodiments, various modifications thereto will be apparent to those skilled in the art without departing from the spirit and scope of the invention as outlined in the appended claims. The entire disclosures of all references recited above are incorporated herein by reference.

1. A surface projection system for augmented reality, comprising:
a surface projection device positionable adjacent a surface, comprising:
a light element configured to project a reference pattern on the surface; and
a sensor adjacent the surface and configured to gaze along the surface.

2. The surface projection system of claim 1, wherein the sensor is configured to detect one of light interference and sound interference along the surface.

3. The surface projection system of claim 1, wherein the reference pattern projected by the light element is invisible to a human eye.

4. The surface projection system of claim 3, wherein the light element projects the reference pattern using infrared light.

5. The surface projection system of claim 1, wherein the reference pattern comprises a grid pattern.

6. The surface projection system of claim 1, wherein the reference pattern comprises a boundary for the surface.

7. The surface projection system of claim 1, wherein the sensor comprises a camera.

8. The surface projection system of claim 7, further comprising:
a processor configured to recognize gesture input captured by the camera.

9. The surface projection system of claim 8, wherein the processor is configured to cause the light element to transform the projected reference pattern in response to the recognized gesture input.

10. The surface projection system of claim 9, wherein the reference pattern projected is one of translated along the surface, scaled, and rotated.

11. The surface projection system of claim 1, wherein the light element projects an object at a location in the reference pattern.

12. The surface projection system of claim 1, further comprising:
a head mounted display having a camera configured to capture the reference pattern on the surface.

13. The surface projection system of claim 12, wherein the head mounted display further comprises:
a processor configured to generate and overlay computer-generated imagery (“CGI”) atop of the reference pattern via the head mounted display.

14. The surface projection system of claim 13, wherein the CGI comprises an object that is presented at a location on the reference pattern by the head mounted display.

15. The surface projection system of claim 14, wherein the location of the object is transformed as the reference pattern is transformed.

16. The surface projection system of claim 1, wherein the surface projection device further comprises:
a communications module configured to communicate one of gesture input and at least one dimension of the reference pattern registered by the sensor to a head mounted display.

17. The surface projection system of claim 7, wherein the surface projection device further comprises:
a communications module configured to communicate with a head mounted display; and
a processor configured to use the reference pattern captured by the camera to measure at least one dimension of the reference pattern projected on the surface and communicate the at least one dimension to the head mounted display via the communications module.

18. A surface projection system for augmented reality, comprising:
a surface projection device, comprising:
a light element configured to project a reference pattern on a plane; and
a sensor adjacent the plane and configured to gaze along the plane.

19. A surface projection system for augmented reality, comprising:
a surface projection device positionable adjacent a surface, comprising:
a light element configured to project a reference pattern on a surface; and
a sensor adjacent the surface and configured to gaze along the surface; and
a head mounted display, comprising:
a camera configured to capture the reference pattern on the surface; and
a processor configured to generate and overlay CGI atop of the reference pattern.
